(19) United States
(12) Patent Application Publication
(10) Pub. No.: US 2008/0246290 A1
(43) Pub. Date: Oct. 9, 2008

(54) Method for Manufacturing a Gripping Means Having Integrated Vacuum Channels

(76) Inventor: Kenny Johansson, Bredaryd (SE)

Correspondence Address: DICKSTEIN SHAPIRO LLP, 1825 EYE STREET NW, Washington, DC, 20006-5403, US

(21) Appl. No.: 10/571,003

(22) PCT Filed: Jun. 21, 2005
(86) PCT No.: PCT/SE2005/000975

§ 371 Date: Mar. 8, 2006

(30) Foreign Application Priority Data
Jun. 23, 2004 (SE) 0401621-8

(51) Int. Cl. B66C 1/02

(52) U.S. Cl. 294/65

(57) ABSTRACT

The present invention refers to a method for manufacturing a gripping means for fixing of a detail intended to be handled by aid of a robot arm on a robot and said gripping means comprises an optional number of suction cup provided arms (2) having vacuum channels (8) integrated in a collecting channel (7). Said gripping means (1) is manufactured by freeforming in a solid material unit having integrated vacuum channels (8), which are assembled in an integrated collecting channel (7) in the centre (3) of the gripping means (1) and which in turn is assembled to a connecting channel (9) integrated to said collecting channel (7), in the outer end of which a vacuum nipple (5) is connectable in providing a gripping means, which is directly adapted to its function and as to its material is optimized to the lowest weight.

The present invention refers to a method for manufacturing a gripping means for fixing a detail intended to be handled by aid of a robot arm on a robot and said gripping means comprises an optional number of suction cup-provided arms having vacuum channels integrated in an assembling channel.

More and more robots are today used within the industry for lifting details, to orientate details, take out details from plunger moulding machines etc. On said robot arm a gripping means is situated, which gets hold of or fastens to that detail, which is to be treated. A very much useful and gentle way for handling is carried out by aid of vacuum and suction cups, which fixes to the detail. Those gripping means used today are constructed with special designed aluminium profiles as supports of hoses and suction cups. These must be very careful secured along the profiles, so that all movements can be performed without having said hoses and cables being subjected to unnecessary influence. The time to assemble the gripping means and the adjustment of all hoses involves a lot of dispenses, when it often requires a great accuracy. Many times vacuum losses can occur if wrong hose dimensions are used or too long hoses. There is also a risk that the gripping means can change itself during transport and storage.

One object of the present invention is therefore to provide a better solution by a method for manufacturing of simple or complicated gripping means having integrated vacuum channels in a simple and rational way by free-forming. In this way a gripping means is provided, which is directly adapted for its function and as to its material is optimized to the lowest weight. It is desired that the gripping means is as light as possible as this influences the cycle time. In using the free-forming method all necessary channels and connections integrated in the gripping means are obtained and it only remains to mount the suction cups and connect the gripping means to an actual vacuum socket. The great advantage with the invention is the possibility to obtain complex geometries, to shorten recurrent times and lower the costs.

The present invention is based on a method that by free-forming manufacture gripping means having integrated vacuum channels. In this way there are possibilities to design complicated forms and also forms, which are enclosed in other enclosed forms, so that the capacity of the system can be used to design “impossible” objects. The gripping means is designed by aid of CAD, whereupon the gripping means with a great precision can be manufactured by free-forming. Further gripping means having the same design can just like that be made having exact measurement accuracy. A gripping means having several arms will be very light and can be provided with a connection in the centre and suction cups in the ends of the arms. In each arm the integrated vacuum channels run, which are assembled in the centre of the gripping means.

The invention will now be described in more detail below with help of a preferred embodiment example with reference to the accompanying drawing, on which

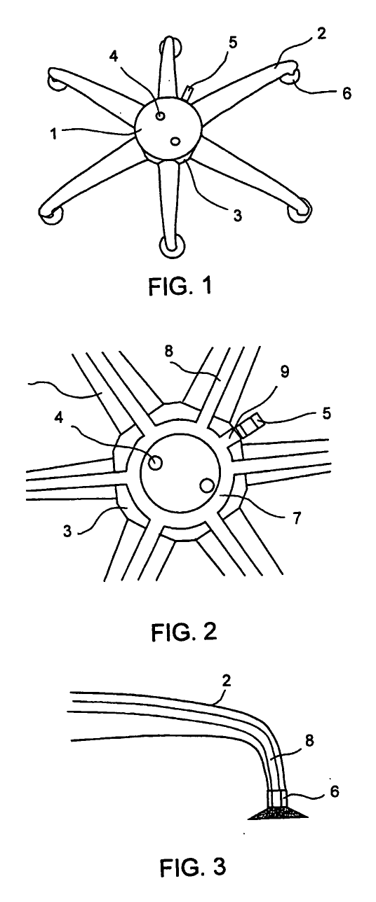

FIG. 1 shows a gripping means having arms and integrated vacuum channels, which are manufactured using the method of free-forming,

FIG. 2 shows the centre of a gripping means having arms with integrated vacuum channels, a centre with integrated assembling channel and integrated connection channel, manufactured in using the method for free-forming and

FIG. 3 shows how the suction cups are connected to the vacuum channels in a gripping means manufactured in using the method for free-forming a gripping means having integrated vacuum channels.

The figures are illustrating a gripping means manufactured by free-forming with integrated vacuum channels 8 according to a preferable embodiment example of the present invention. In FIG. 1 a free-formed gripping means 1 having arms 2 is illustrated, which meet each other in a centre 3 having two openings 4 for fixing against a robot arm or the like. Further a vacuum nipple 5 is illustrated for connection to a vacuum source. In the ends of each arm 2 suction cups 6 are connectable to the vacuum channels 8.

In FIG. 2 the inside of the centre 3 in a free-formed integrated gripping means 1 having arms 2 is illustrated and also vacuum channels 8, which are integrated in said arms 2. The vacuum channels 8 are connected to an assembling channel 7, which via a connecting channel 9 gives the possibility to connect said vacuum nipple 5. The arms 2, the centre 3 the assembling channel 7 and the vacuum channels 8 are by the free-forming method manufactured in one and the same piece or part, where everything is integrated.

The result of a method that by free-forming in a solid material unit manufacture gripping means having integrated vacuum channels can be seen from FIG. 3, from which figure it is evident how one of the vacuum channels 8 is connected to a suction cup 6 in a free-formed integrated gripping means 1 and where the vacuum channels 8 are integrated in an arm 2.

In the now described embodiment example a gripping means is illustrated having integrated arms, manufactured according to the invention by free-forming. Of course according to the invention it is possible to provide other forms of a free-formed integrated gripping means in the form of a e.g. a plate having recesses for suction cups. According to the inventive method it is also possible to provide free-formed integrated gripping means, which before have been considered to be impossible to manufacture. Thus, the invention shall not be considered to be limited to what has been illustrated and described above but similar variants are included in the invention idea and must be regarded to be included within the scope of the following claims.

1. A method for manufacturing a gripping means for fixing of a detail intended to be handled by aid of a robot arm on a robot and said gripping means comprises an optional number of suction cup provided arms (2) having vacuum channels (8) integrated in a collecting channel (7), characterized in that said gripping means (1) is manufactured by free-forming in a solid material unit having integrated vacuum channels (8), which are assembled in an integrated collecting channel (7) in the centre (3) of the gripping means (1) and which in turn is assembled to a connecting channel (9) integrated to said collecting channel (7), in the outer end of which a vacuum nipple (5) is connectable in providing a gripping means, which is directly adapted to its function and as to its material is optimized to the lowest weight.

2. A method according to claim 1, characterized in that the integrated vacuum channels (8) are formed in having to the same connectable suction cups (6) in their outer ends.

3. A method according to claim 1, characterized in that the gripping means (1) comprises an optional number of arms (2) having integrated vacuum channels (8).
